(19) United States
(12) Patent Application Publication
(10) Pub. No.: US 2007/0182170 A1
(43) Pub. Date: Aug. 9, 2007

(54) Vehicle bumper including a tow ring insert

(76) Inventors: Thierry Renault, Vernon (FR); Denis Luet, Gaillon (FR)

Correspondence Address: Blakely Sokoloff Taylor & Zafman, 12400 Wilshire Boulevard 7th Floor, Los Angeles, CA, 90025, US

(21) Appl. No.: 10/590,842

(22) PCT Filed: Feb. 28, 2005
(86) PCT No.: PCT/FR05/00469

§ 371 Date: Aug. 24, 2006

(30) Foreign Application Priority Data
Feb. 27, 2004 (FR) 0401996

(51) Int. Cl. B60R 19/56

(52) U.S. Cl. 293/102

(57) ABSTRACT

A vehicle bumper (2) with a beam (4) comprising at least one synthetic material. The bumper includes a tow ring insert (6).

The invention concerns vehicle bumpers. It is conventional to place on the bumpers of vehicle a towing and maritime mooring ring that is rigidly fixed to a metal bumper beam. In this case, a specification schedule specifies that the beam can accommodate the removable ring by screwing it into an insert secured to the beam. In this specification schedule, three cases of loading are used to dimension the ring and its fixing insert:
traction and compression in the axis of the insert, with half of the weight of the vehicle as load;
extraction from a ditch: this involves traction with angles along direction Y (horizontal transverse direction) and direction Z (vertical direction) with half of the weight of the vehicle, and
maritime mooring, which involves traction downwards with a force equal to 40% of the weight of the unloaded vehicle.

One objective of the invention is to allow the fixing of a towing ring to a bumper whose beam is made from a composite material. To this end, the invention proposes a bumper for a vehicle, including a beam that has at least one synthetic material, where the bumper includes an insert to receive a towing ring.

The bumper of the invention can also have at least any one of the following characteristics:
the insert is fixed directly to the beam;
the insert is accommodated in a housing made of synthetic material;
the synthetic material is in contact with the insert over the whole of the housing;
the housing is in the form of a sleeve;
the insert has a small collar;
the insert has one end crimped;
the insert includes a metal;
the beam is composed of at least one synthetic material;
the beam includes reinforcing fibres;
the insert is secured to an absorber on the beam; and
the insert is secured to a bar on the beam.

The invention also proposes a process for the manufacture of a vehicle bumper, in which an insert is placed to receive a towing ring in a bumper which includes a beam that has at least one synthetic material. The process of the invention can also have at least any one of the following characteristics:
the insert is fixed directly to the beam;
the (or each) material intended to form the beam is heated, and is then placed in a mould;
the (or each) material is compressed when the mould is closed;
a space-forming part is moved within the mould to form a housing;
the movement takes place after closure of the mould;
the insert is positioned in the housing;
the insert is positioned in the housing while the beam is at a temperature greater than ambient temperature; and
the insert is crimped onto the beam.

Finally, the invention proposes a mould for the production of a bumper beam for a vehicle, including a chassis and a space-forming part mounted to be mobile in a cavity of the mould in relation to the chassis.

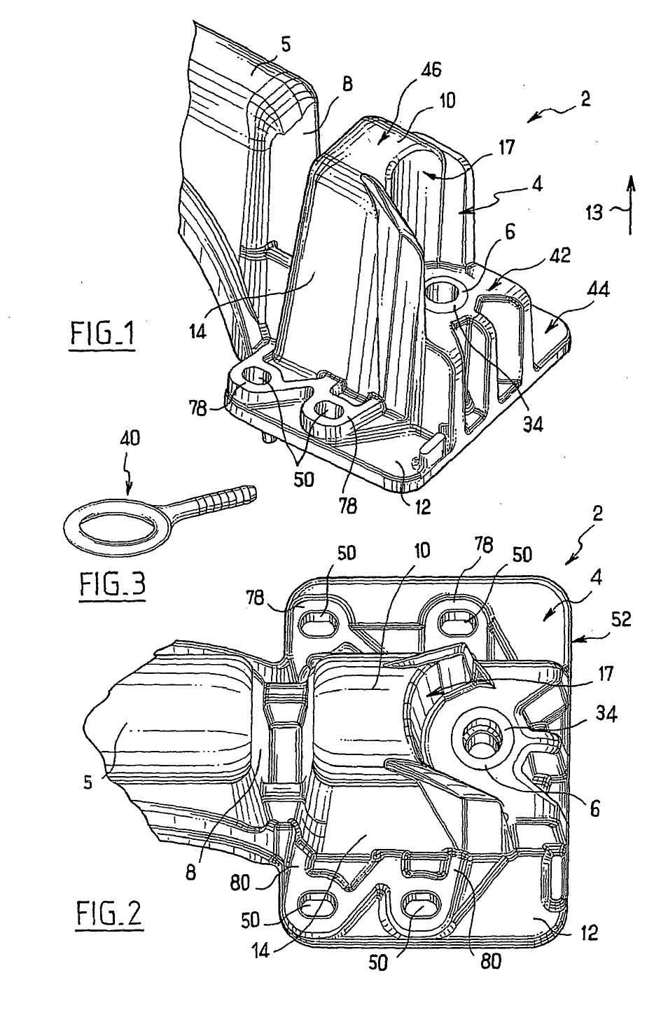

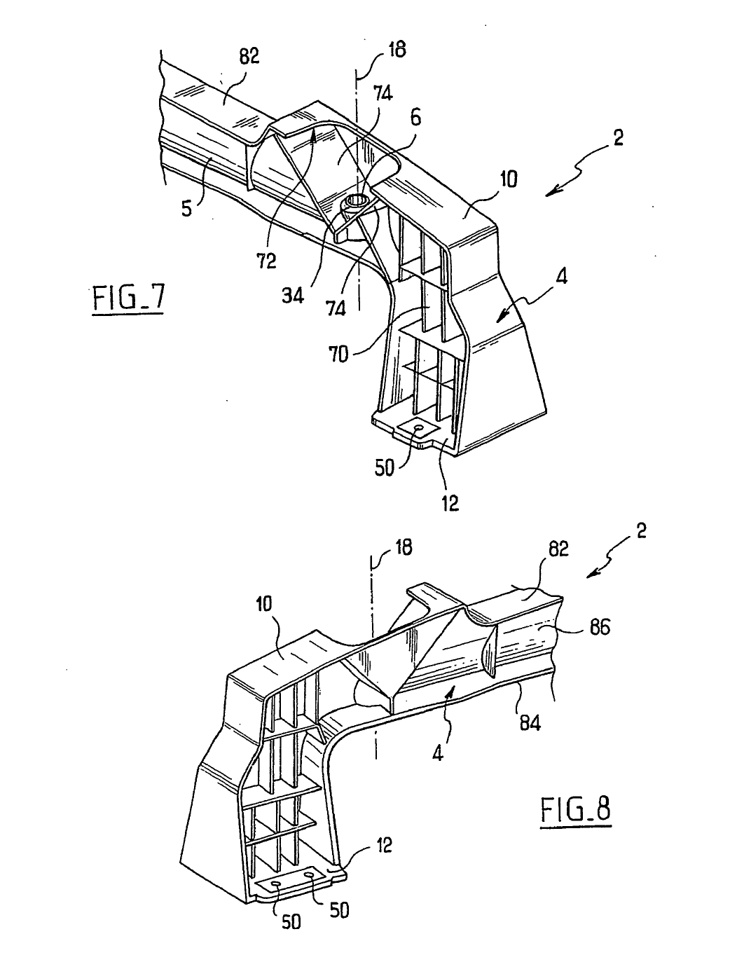

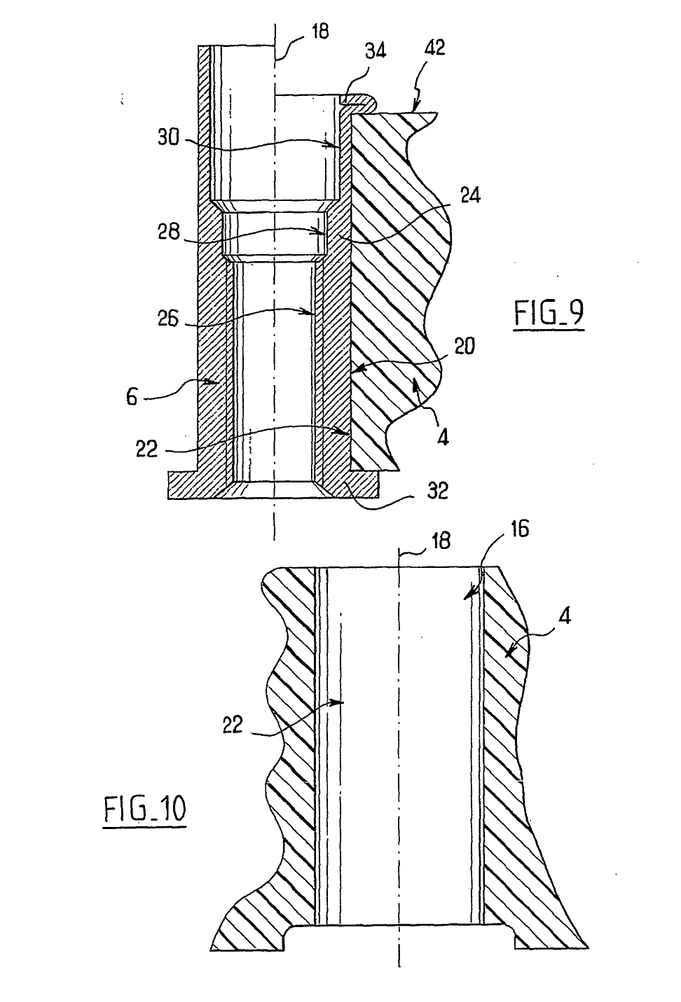

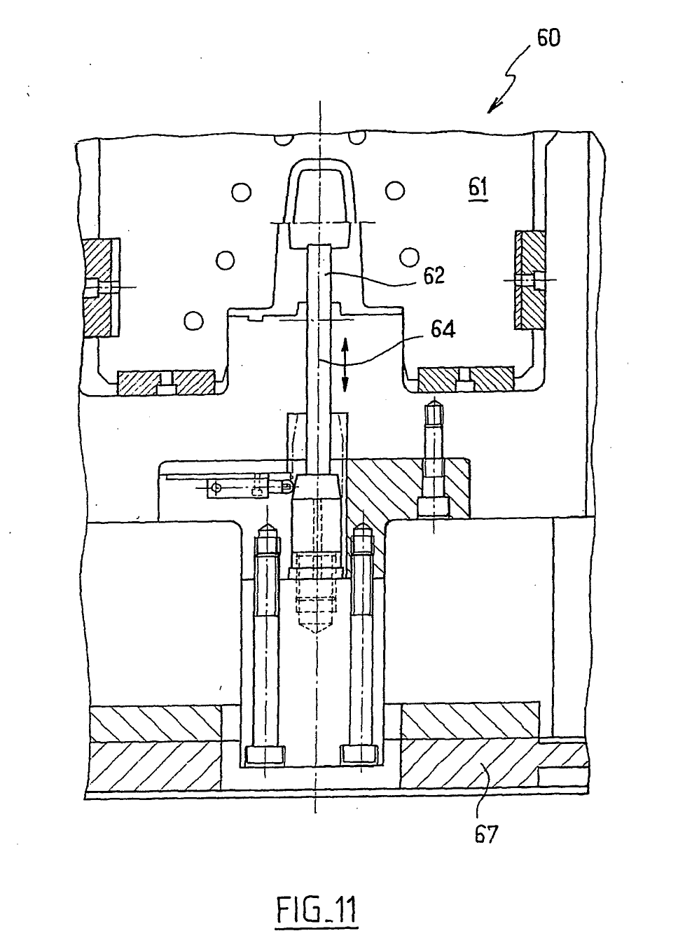

Other characteristics and advantages of the invention will appear on reading the following description of three methods of implementation given by way of unlimited examples with reference to the appended drawings in which:
FIGS. 1 and 2 are two partial views in perspective illustrating a bumper beam according to a first method of implementation of the invention;
FIG. 3 is a view in perspective of a ring intended to be accommodated in the insert of the beam in FIGS. 1 and 2;
FIGS. 4, 5 and 6 are three views similar to FIGS. 1 and 2, illustrating a second method of implementation of the beam according to the invention;
FIGS. 7 and 8 are two views similar to FIGS. 1 and 2, illustrating a third method of implementation of the beam;
FIG. 9 is a view in axial section of an insert forming part of the beams of FIGS. 1 and 2 and 4 to 8;
FIG. 10 is a view in axial section of the housing created in the beams of FIGS. 1 and 2 and 4 to 8, for reception of the insert of FIG. 9; and
FIG. 11 is a partial view in elevation of a mould for the creation of a beam according to the invention.

FIGS. 1 and 2 illustrate a first method of implementation of a bumper 2 according to the invention. The bumper is a front bumper in this case. The bumper includes a beam 4 and an insert 6 secured to the beam.

The beam includes a bar 5 extending over most of the length of the beam in a median zone of the latter. Facing the two longitudinal ends 8 of the bar 5, the beam includes two absorbers 10 whose base is formed by a plate 12 that has a generally flat shape perpendicular to a direction of travel 13 of the vehicle. The absorber 10 includes a body 14 extending toward the front, projecting from the plate 12, and that has a cross section in a plane parallel to the plate 12 and narrower than the latter. This means that the edges of the plate project from the body 14 in a plane perpendicular to direction 13.

Generally, the beam will be made up and manufactured according to the description in document FR-2 835 793. It will therefore be composed of at least one thermoplastic material for example, reinforced with fibres such as glass fibres. These fibres can be unidirectional, grouped to form mats or indeed woven into each other. The beam 4 is all in a single block, and manufactured in a single moulding operation by compression, as will be described later. Alternatively, the beam can be manufactured in a heat-hardened material.

The plate 12 of each absorber 10 is designed to be fixed to one end of a stretcher beam in the structure of the vehicle.

The bumper includes a skin of synthetic material (not shown) and is intended to hide the beam from sight from the outside of the vehicle.

The insert 6 is created from a metal such as steel. It is accommodated in a housing 16 of the beam which, as it happens, is created in one of the absorbers 10. As illustrated in FIG. 10, the housing 16 has a general sleeve-like shape which happens to be a cylindrical shape on axis 18. As illustrated in FIGS. 9 and 10, the synthetic material of the beam 4 is in contact with the insert 6 over the whole of the housing. In particular, the insert 6 has an outer face 20 of cylindrical shape creating a surface to counter-surface contact with the cylindrical face 22 of the housing 16.

The insert has a general sleeve-like shape, illustrated in detail in FIG. 9. It has a cylindrical wall 24 whose face 20 constitutes the outer face. Here the insert is formed in the shape of a metal stud. It has several cylindrical inner faces 26, 28 and 30 succeeding each other along the axis 18 of the insert from a first axial end 32 of the insert 6 up to a second end 34. The faces 26, 28 and 30 have respective diameters which increase from end 32 up to end 34. Face 26, of smaller diameter, extends over more than half of the length of the insert 6 in the present example. It is also threaded so as to be able to fit onto a towing and mooring ring by a nut & bolt connection, like the ring 40 illustrated in FIG. 3. At its end 32, insert 6 has a collar extending radially, projecting from the face 20 and butted up against a rear face of the plate.

The end 34 of the insert is crimped onto an intermediate face 42 of the absorber, extending globally mid way between a front face 44 of the plate 12 and a front face 46 of the absorber.

As can be seen in FIG. 1, the body 14 of the absorber has a recess 17 to the right of the insert 6 when looking at the absorber from the front of the vehicle, to provide access to the insert in order to position the ring 40.

Each of the plates 12 has four orifices 50 for fixing the plate to one face of the corresponding stretcher beam. As can be seen in particular in FIG. 2, the insert lies, in a plan view of the plate, close to an outside edge 52 of the latter opposite to the bar 5. The orifices 50 are placed in a rectangle, this rectangle being located between the insert and the bar 5 in plan view, so that the orifices are all closer to the bar than the insert.

The bumper that has just been described is created as follows:

First, one or more blanks of synthetic materials intended to constitute the beam 4 are heated. It is arranged that the heating temperature is between 150 and 250° C. and can be 200° C. for example.

The (or each) blank is then inserted into a compression mould 60 like that illustrated in FIG. 11. This mould conventionally includes a die and a punch which are mobile in relation to each other and forming a cavity 61 in the mould. Closure of the mould is effected by bringing the die and the punch together. During this closure, the (or each) material is compressed, which gives its general shape to the beam 4.

In the present example, the mould includes a space-forming part 62 mounted to be mobile and to slide along an axis 64 in relation to a chassis 67 of the mould 60. Here, part 62 has a cylindrical shape and constitutes a jack. The axis 64 corresponds to the axis of the cylinder. After closure of the mould, the jack 62 is moved to form the housing 16 intended to receive the insert 6. This jack therefore compresses the material present in the mould after it is poured and installed and positioned. The jack has a diameter of about 80 mm and exerts a pressure of about 80.10⁶ Pa.

Thus, the zone of the beam intended to receive the insert 6 later is filled with material in a first stage. The latter is then chased by the compacting jack. This excess material is still hot and is capable of flowing so that it can take up position in the remainder of the part. In this present example, the movement of the jack to create the housing is toward the front with reference to the vehicle along direction 13.

The mould is then opened and the beam is removed from the mould.

The formation of the housing by means of the mobile jack constitutes a web of material at the level of the housing 16 and across it. This web can be drilled prior to installation of the insert.

When the part has been removed from the mould, the insert 6 is mounted in the beam while the latter is still hot, that is at a temperature more or less above ambient temperature. This will provide a certain assembly play between the beam and the insert. Later, the material will tighten up on the insert as it cools.

The insert is positioned so that the collar 32 lies against the rear face of the plate 12 opposed to a possible traction force. This therefore gives it a good bearing surface on the beam in the event of traction. The faces 28 and 30 of the insert, with their edges, form a guidance zone which is used to limit the torque on the ring when this is located in the insert, in the presence of forces which are not oriented along axis 18.

This is followed by an operation to crimp the insert onto the beam. In the half view extending to left of the axis 18, FIG. 9 then shows the insert in its front crimped form, and in the half view extending opposite to the insert in its form after crimping. This crimping consists of pressure by folding the end zone 34 of the insert so that it extends radially, projecting from the face 20, and is applied against the front face 42 of the plate. This therefore constitutes a bead which enables it to respond to compression conditions oriented at 0° in relation to the axis 18.

In this first method of implementation, extra thicknesses 78 can be provided along direction 13 in the plate at the level of the orifices 50. These extra thicknesses can lead to total thicknesses of between 8 and 17 mm. The extra thicknesses thus constitute rims around the orifices 50. Ribs 80 can also be provided connecting these extra thicknesses to the body of the absorber. The strengtheners constituted by the extra thicknesses 78 and the ribs 80 reduce the risk of tearing out by shearing in case of force or shock. In particular, it can be seen that the most stressed fixing points of the orifices 50 are the points located above and close to the ring, since the most unfavourable loading cases are those directed downward.

A second method of implementation of the beam according to the invention is illustrated in FIGS. 4 to 6. This differs from the precedent one, essentially by the position of the insert 6 in relation to the beam. Thus, in the present example, the absorber 10 receiving the insert 6 has a central cavity 64, with the front face 46 of the absorber being absent. The housing is formed in the direction of the rear of the vehicle from the face 42 which constitutes the bottom of this cavity 64.

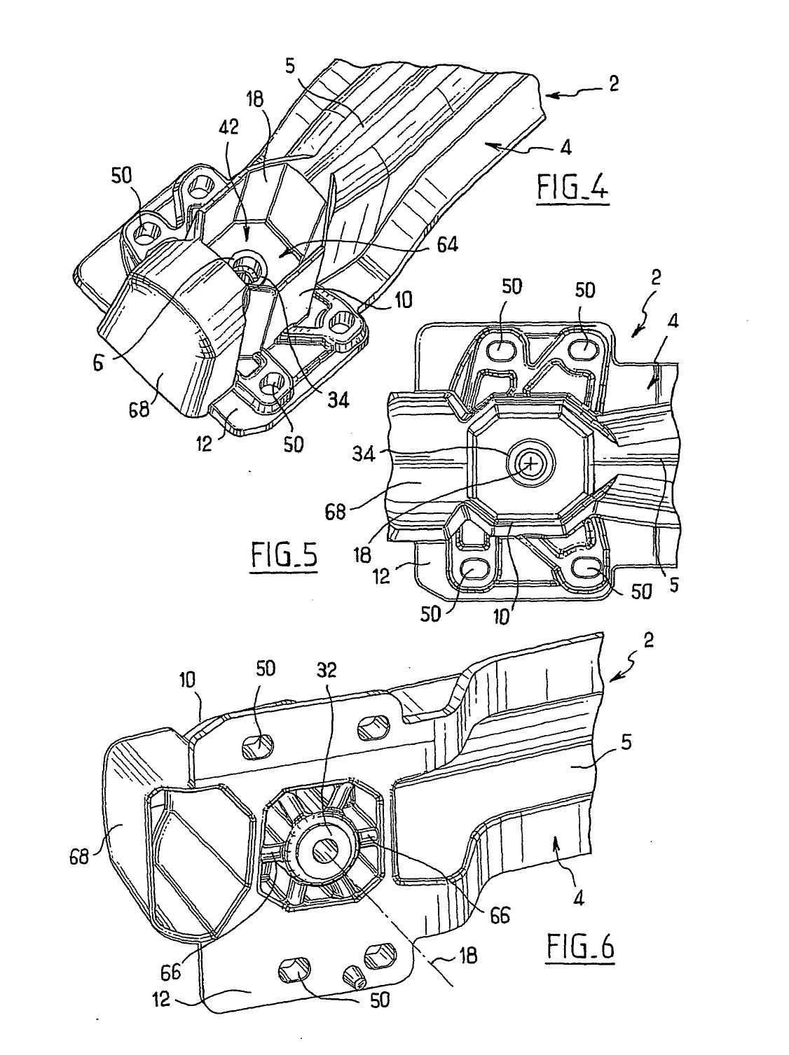

As can be seen in particular in FIG. 5, the insert lies this time, in plan view, on the inside of the rectangle formed by the four orifices 50. FIG. 6 illustrates the beam with its absorber in rear view. It can be seen that the absorber is in fact recessed between its main wall and the wall forming the housing 16. Spacers 66 oriented radially in relation to the axis 18 of the housing are provided in order to give the assembly the necessary stiffness. These spacers are six in number.

FIGS. 4 to 6 show that the absorber is extended in the direction of the longitudinal end of the beam by a secondary absorber body 68 that has a closed-off front face and forming a housing.

A third method of implementation is illustrated in FIGS. 7 and 8. Here, each absorber 10 is formed by an extension of the beam toward the rear of the vehicle and by a network of ribs 70 formed by a series of ribs extending along the direction of travel of the vehicle and another series of ribs crossing the preceding ones and extending across this direction of travel. All the ribs are arranged in a vertical plane, with a flat shape.

In this method of implementation, the insert 6 is here secured to the bar and not to the absorber 10. To this end, the front face of the bar has a recess 72 and the bar includes two walls 74 that have a V shape in plan view. The point of the V is directed toward the rear of the vehicle, with the walls each extending in a vertical plane and each with a flat shape. As in the previous methods of implementation, the insert 6 is placed with its axis 18 extending in a horizontal plane along the direction of travel of the vehicle.

In this third method of implementation, the bar has an H-shaped cross-section so that it has a front wall 82 and a rear wall 84 and wall 86 between them. Walls 82 and 84 are essentially flat and vertical and are located opposite to each other. Wall 86 is essentially horizontal and extends from wall 82 to wall 84, being slightly corrugated from wall 82 to wall 84.

As can be seen in these different methods of implementation, the position of the towing insert is chosen to be close to the points fixing the beam to the structure of the vehicle.

The invention does not however prevent the beam from meeting the requirements of the usual specifications in relation to parking impacts and repair stresses.

The advantage of the implementation of the insert housing by means of a mobile jack is that one avoids the creation of a material welding zone which would inevitably constitute a zone of weakness in the part. Through the aforementioned compacting process, the zone receiving the insert has an even distribution of reinforcing fibres with good mechanical performance. Where appropriate, it is possible to arrange that the compacting jack is moved toward the front or toward the rear for formation of the housing.

It is naturally possible to make many changes to the invention without moving outside the scope of the latter.

It can be arranged that the beam is made of several thermoplastic or thermohardened materials, for example

It can also be a rear bumper.

1. A bumper (2) for a vehicle, including a beam (4) that has at least one synthetic material, characterised in that it includes an insert (6) to accommodate a towing ring (40).

2. A bumper according to claim 1, characterized in that the insert (6) is fixed directly onto the beam (4).

3. A bumper according claim 1, characterized in that the insert (6) is accommodated in a hosing (16) made of synthetic material.

4. A bumper according to claim 3, characterized in that the synthetic material is in contact with the insert (6) over the whole of the housing (16).

5. A bumper according to claim 3, characterized in that the housing (16) is in the form of a sleeve.

6. A bumper according to claim 1, characterized in that the insert (6) has a small collar (32).

7. A bumper according to claim 1, characterized in that the insert (6) has one end crimped (34).

8. A bumper according to claim 1, characterized in that the insert (6) includes a metal.

9. A bumper according to claim 1, characterized in that the beam (4) is composed of at least one synthetic material.

10. A bumper according to claim 1, characterized in that the beam (4) includes reinforcing fibres.

11. A bumper according to claim 1, characterized in that the insert (6) is secured to an absorber (10) on the beam (4).

12. A bumper according to claim 1, characterized in that the insert (6) is secured to a bar (5) on the beam (4).

13. A process for the manufacture of a bumper (2) for a vehicle, characterized in that an insert (6) is placed to accommodate a towing ring (40) in a bumper that includes a beam (4) that has at least one synthetic material.

14. A process according to claim 13, characterized in that the insert (6) is fixed directly to the beam (4).

15. A process according to claim 13, characterized in that the material intended to form the beam is heated, and is then placed in a mould (60).

16. A process according to claim 15, characterized in that the material is compressed when the mould is closed (60).

17. A process according to claim 15, characterized in that a space-forming part (62) is moved within the mould to form a housing (16).

18. A process according to claim 17, characterized in that the movement takes place after closure of the mould.

19. A process according to claim 17, characterized in that insert (6) is positioned in the housing (16).

20. A process according to claim 17, characterized in that the insert (6) is positioned in the housing (16) while the beam (4) is at a temperature greater than ambient temperature.

21. A process according to claim 13, characterized in that the insert is crimped (6) onto the beam (4).

22. A mould for the manufacture of a beam (4) for vehicle bumpers (2), including a chassis (67), characterized in that it includes a space-forming part (62) mounted to be mobile in a cavity (61) of the mould in relation to the chassis.
